(19) United States
(12) Patent Application Publication
(10) Pub. No.: US 2007/0201867 A1
(43) Pub. Date: Aug. 30, 2007

(54) METHOD, APPARATUS, SYSTEM AND COMPUTER PROGRAM PRODUCT FOR IDENTIFYING FAILING OR FAILED OPTICAL NETWORK TERMINAL(S) ON AN OPTICAL DISTRIBUTION NETWORK

(75) Inventors: David A. DeLew, Rohnert Park, CA (US); Joseph D. Miguel, Petaluma, CA (US); Bernardus F. Egberts, Petaluma, CA (US)

Correspondence Address: FITZPATRICK CELLA HARPER & SCINTO, 30 ROCKEFELLER PLAZA, NEW YORK, NY, 10112, US

(73) Assignee: Tellabs Petaluma, Inc., Petaluma, CA (US)

(21) Appl. No.: 11/419,695

(22) Filed: May 22, 2006

Related U.S. Application Data
(60) Provisional application No. 60/743,380, filed on Feb. 28, 2006.

(51) Int. Cl. H04B 10/08

(52) U.S. Cl. 398/38

(57) ABSTRACT

An error in a passive optical network is identified by communicating to an optical network terminal on the passive optical network a request to transmit a response signal at a predetermined power level, receiving the response signal in response to the request, and measuring a power level of the response signal. A predetermined channel power level is compared to the power level of the response signal and a status of the optical network terminal is determined based on the result of the comparison.

### CROSS REFERENCE TO RELATED APPLICATIONS

This application claims priority to, and the benefit of, U.S. Provisional Patent Application Ser. No. 60/743,380, filed Feb. 28, 2006, which is hereby incorporated by reference in its entirety.

### BACKGROUND OF THE INVENTION

1. Field Of The Invention

The present invention generally relates to passive optical networking (PON) error detection, and more particularly to identifying optical network terminal (ONT) malfunctions within a PON.

2. Related Art

Generally, a passive optical network (PON) is made up of fiber optic cabling, passive splitters and couplers that distribute an optical signal through a branched tree topology referred to as an optical distribution network (ODN). Each fiber segment is terminated at a connector to make a connection to devices at a customer's premises. A PON optical-line terminal (OLT) transmits a light signal through the fiber and passive splitters, and distributes the light signal to customers, where it is converted into an electronic format by an optical-network terminal (ONT) for use by the customer devices.

Active optoelectronic equipment is located at the sending (i.e., OLT) and receiving (i.e., ONT) ends, while the ODN includes passive components. In point-to-multipoint systems, a PON may include one or more OLTs located at a central office for servicing groups of downstream ONTs.

The process of transporting data downstream to the customer premises is different from transporting data upstream from the customer premises. Downstream data is broadcasted from the OLT to each ONT, and each ONT processes the data destined to it by matching the address in the protocol transmission unit header. Upstream traffic is more complicated due to the shared media nature of the ODN. In order to avoid collisions, transmissions from each ONT to an OLT are coordinated by transmitting upstream data according to control mechanisms in the OLT, based on, for example, a TDMA (time division, multiple access) protocol, in which dedicated transmission time slots are granted to each individual ONT. The time slots are synchronized so that transmission bursts from different ONTs do not collide.

Several PON standards have been promulgated. APON (ATM PON) uses Asynchronous Transfer Mode (ATM) for transport, and BPON (Broadband PON) includes APON, Ethernet and video transports. GPON (Gigabit PON) uses the SONET GPF frame. BPON and GPON are the ITU-T G.983 and G.984 standards respectively. EPON is the IEEE Ethernet standard for PONs.

As with most electronic equipment, an ONT can malfunction. In some cases ONT malfunctions are catastrophic to communications. For example, one common ONT malfunction causes it to send a continuous light signal (modulated or unmodulated) up the shared fiber of an optical distribution network (ODN). This can make it impossible for the OLT to communicate with any of the ONTs on the ODN. As will be described in more detail below, in some cases an ONT emits signs that it is eventually going to fail.

A PON transceiver in an OLT is programmed to identify powered-on ONTs cards that are ready to receive commands. This process, also referred to as ranging, can be blocked when an error exists. In addition, once an ONT is ranged, the presence of an error might be undetectable until ranging reoccurs. Ranging typically is initiated when an ONT is rebooted or when another ONT card is added, and therefore does not reoccur often. Thus, only when the ranging process needs to reoccur will such a range blocking type error be detected.

In a PON system, multiple ONTs transmit data to the OLT using a common optical wavelength and shared fiber optic media. Particularly, all the ONT units share the one upstream fiber to the PON and are configured to communicate with the PON during a predetermined time slot. Another type of ONT malfunction is when it sends a light signal up to the OLT at inappropriate times while attempting to establish communications or after having established communications with other ONTs on the ODN. This results in the OLT not being able to communicate with any of the ONTs on the ODN.

A malfunctioning ONT might also send a signal up to the OLT with an inappropriate power level. In particular, an ONT might send a power level that is just below the threshold of the PON. This can occur, for instance, when an ONT laser begins to fail. Or, an ONT might send a power level that is just above the threshold of the PON. This problem can also occur, for example, due to a failing laser. Another reason an upstream signal might be above a threshold of the PON is when there is not enough attenuation between the OLT and the ONT because there is not enough fiber optic cabling between the OLT and ONT. In either case, the problem can make it impossible for the OLT to communicate with that ONT on a continuous basis and can cause disruptions in service, and signal sporadic alarms from either the OLT or ONT to a network operator as communications are lost.

A typical PON protocol provides some functionality for detecting these problems in a limited way, usually only as they relate to inappropriately modulated signals. For example, only hardware errors or CRC errors that may occur are detectable. Using existing error detection techniques (e.g., those described in the various PON protocols), the above-identified ONT malfunctions may not be detected or, even if detected (e.g., by system failure), may not be identified.

One conventional way to detect problems is to individually disconnect ONTs from the ODN and determine if there is a single ONT that has this problem and particularly which ONT is the source of the problem. Another conventional way to detect such problems is to disconnect the ODN from the OLT and examine the ODN with additional test equipment. While actual data such as CRC errors or errors in the framing headers can be analyzed, neither side of the network has any explanation of why the problem is occurring. Nor do these conventional troubleshooting techniques identify in situ the identity of the problem ONT. Moreover, it becomes impractical and relatively expensive to remove ONTs one by one to repair them.

The detection of un-modulated and modulated signals is not required for normal OLT operation. Moreover, most conventional OLTs only detect the presence of a modulated signal and not an un-modulated signal, or the presence of an un-modulated signal level is removed by the signal conditioning circuitry on the PON's optical receiver (or transceiver) all together. Yet, in some cases the presence of a modulated or un-modulated signal can be used to indicate a system problem even though it may not actually result from communication problems between an OLT and an ONT. Accordingly, it can be useful to utilize modulated and un-modulated signals to detect ONT faults.

In addition, the ends of the fiber optic medium can get dirty or the fiber can inadvertently become bent, which can undesirably attenuate different wavelengths of the transmitted light causing additional problems. These types of malfunctions typically go undetected or are detected only after a total communications failure. Troubleshooting is performed by individually disconnecting ONTs from the ODN and determining with a power meter which pathway(s) have a problem.

There is a need, therefore, for an improved way to detect problems such as rogue ONTs, fibers which are too long, dirty, and bent, as well as expiring laser units, and the like, without disconnecting ONTs from an ODN. There also exists a need to identify such malfunctions earlier to provide a more timely and less costly correction of the problem and reduced customer down time. Given the foregoing, what is needed is an improved method, apparatus, system and computer program product for identifying failing or failed ONTs on an ODN.

### BRIEF DESCRIPTION OF THE INVENTION

The present invention meets the above-identified needs by providing a method, apparatus, system and computer program product for identifying failing or failed ONTs on pathways on an ODN.

An advantage of the present invention is that malfunctioning ONTs or other problems, such as damaged fibers, can be detected without disconnecting the PON components. Another advantage of the present invention is that it identifies the above-mentioned malfunctions in a more timely and less costly manner than do conventional troubleshooting techniques. The present invention also identifies the cause of the aforementioned faults and provides more information to avoid faults and categorize problems.

Advantageously, the present invention detects ONT malfunctions earlier than conventional techniques, leading to a more timely and less costly correction of the aforementioned problems, and reduced customer down time.

With the present invention, no additional test equipment is required as the OLT either has, or could easily be built to have, all of the needed capability for detecting problems, and identifying the exact ONT with a problem, once it is programmed according to the invention to do so.

In accordance with one embodiment of the present invention, there is provided a method, apparatus, system and computer program product for identifying an error in a passive optical network including communicating to an optical network terminal on the passive optical network a request to transmit a response signal at a predetermined power level and receiving the response signal in response to the request. This embodiment also provides measuring a power level of the response signal and comparing a predetermined channel power level to the power level of the response signal. A status of the optical network terminal is determined based on a result of the comparing.

In accordance with another embodiment of the present invention, there is provided a method, apparatus, system and computer program product for identifying an error in a passive optical network including measuring a power level of a signal on the passive optical network, comparing the measured power level to at least one predetermined power level, and determining a fault based on the comparing.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a system diagram of an exemplary PON in which the present invention, according to one embodiment, can be implemented.

FIG. 2 is a flowchart illustrating a process according to one embodiment of the present invention.

FIG. 3 is a flowchart illustrating a process of identifying PON component problems based on signal level histories, according to another embodiment of the present invention.

### DETAILED DESCRIPTION

The present invention is now described in more detail herein in terms of an exemplary system, apparatus, method and computer program product for identifying a malfunctioning ONT in a PON ODN. This system is described for illustration purposes and is not intended to limit the application and scope of the present invention. In fact, after reading the following description, it will be apparent to one skilled in the relevant art(s) how to implement the following invention in alternative embodiments (e.g., B-PON, EPON, APON, etc.).

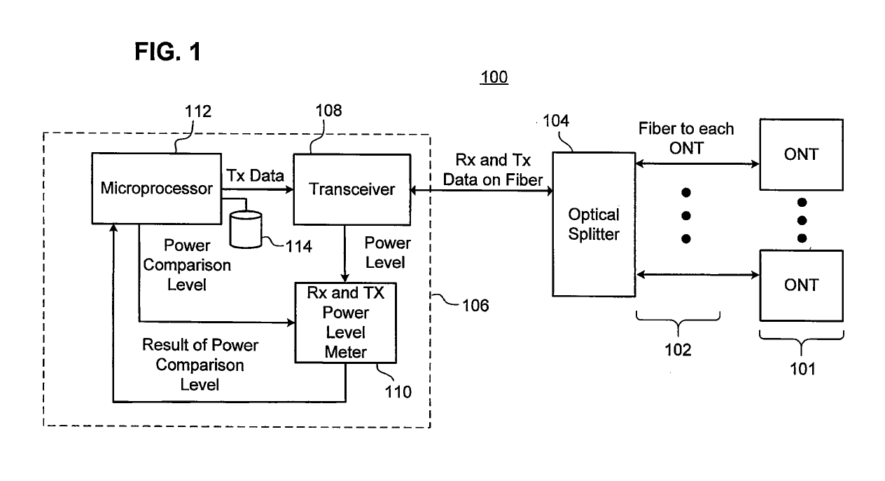

FIG. 1 is a system diagram of an exemplary PON 100 in which the present invention, according to one embodiment, can be implemented. System 100 includes an OLT 106 which is communicatively coupled to an optical splitter 104 through an interface that can include, for example, fiber optic cabling and/or an other suitable type of interface. Optical splitter 104, in turn, distributes optical signals through an interface, such as optical fibers 102 and/or another suitable type of interface (not shown). Thus, an optical signal is distributed through a branched tree network including one or more optical splitters 104 and optical fibers 102, which as explained above is also referred to as an optical distribution network (ODN).

Optical Fibers 102 terminate at connectors (not shown) which in turn connect to individual ONTs 101. Each ONT 101 can be controlled by its own internal microprocessor (not shown), which can be programmed to communicate signals to OLT 106 at different power levels. Upstream directed signals are generated by light sources such as lasers (not shown) in each ONT 101. Optical splitter 104 combines light from ONT 101 light sources resulting in a single light source that is fed into a single fiber directed to OLT 106.

OLT 106 will now be described in more detail in accordance with one embodiment of the present invention. OLT 106 includes a transceiver 108 which is controlled by a microprocessor 112. A power level meter 110 is coupled to transceiver 108 and microprocessor 112 such that it can measure the power level of signals received or transmitted by OLT 106 and communicate them to microprocessor 112. Power level meter 110 can be integrated directly with the transceiver 108 or be separate therefrom.

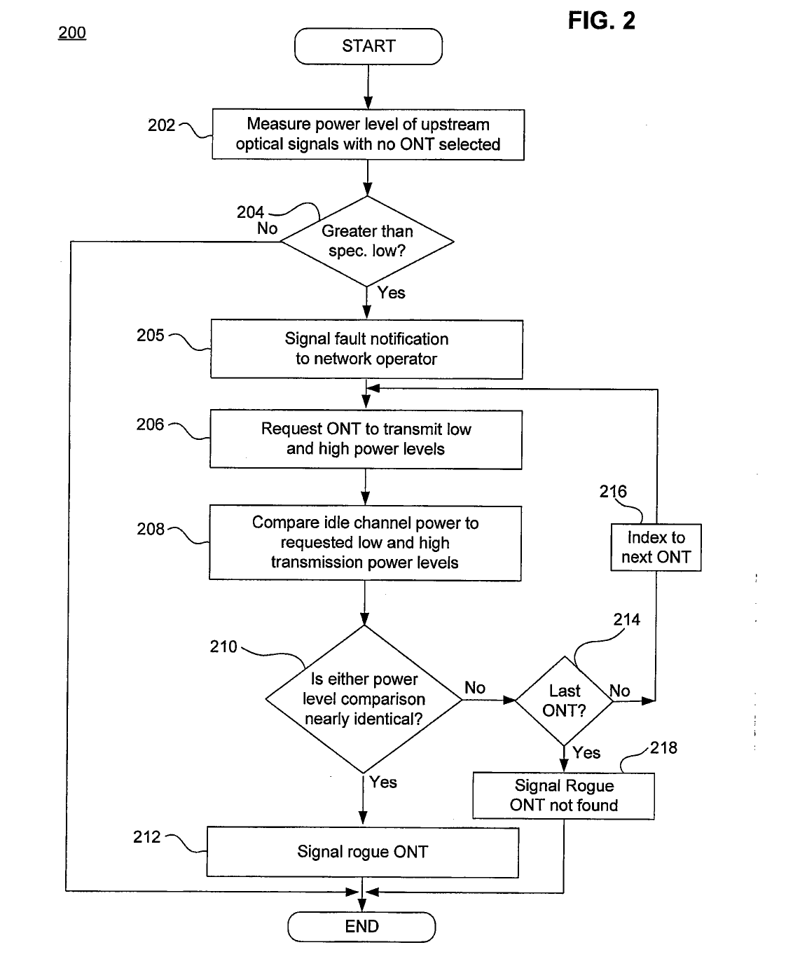

Microprocessor 112 also performs power level comparisons of the signal strengths of the signals transmitted by OLT 106 and the signals received from the ONTs 101. In addition, microprocessor 112 monitors and periodically (e.g., once a day, week, month, and the like) stores the power levels of the signals transmitted by OLT 106 and the power levels of the signals received from ONTs 101 into a memory 114 such as a flash memory, hard-drive, optical disk and the like, which may be within the OLT 106 or external thereto. Also stored in the memory are various programs and routines for controlling operations of the microprocessor 112, and for performing at least part of the method(s) of this invention depicted in FIGS. 2 and/or 3.

FIG. 2 is a flowchart illustrating a process 200 for identifying a malfunctioning ONT according to one embodiment of the present invention. Generally, before attempting to establish (e.g., layer 2) communications with any ONT 101, OLT 106 can detect a malfunctioning ONT by looking for the presence of a modulated or un-modulated upstream optical signal (i.e., from an ONT 101) when none should be present. Referring to FIG. 2, initially at block 202 the power level of the upstream optical signals received by OLT 106 from ONTs 101 are measured by power meter 110 with no ONT 101 selected by OLT 106 (i.e., without the OLT 106 having requested return signals from the ONT 101). This upstream signal power level is referred to as an idle power level (or idle channel power). If a determination is made at block 204 that the idle power level measured by power meter 110 is not greater than a specified low power level, then the process ends. If a determination is made at block 204 that the idle power level measured by power meter 110 is greater than a specified low power level, this means that a rogue (i.e., improperly functioning) ONT has been detected, and at block 205, OLT 106 signals a notification that a fault exists. For example, such a notification can be signaled to a network operator through an output user-interface (not shown), and/or can be forwarded from OLT 106 to a predetermined destination in system 100, such as a network operator terminal. The particular ONT that has been issuing the signals indicating a fault (i.e., the rogue ONT) is detected as follows.

At block 206, OLT 106 selects a first ONT 101 and requests it to transmit first a low power level, then a high power level, during known time slots. The low and high power levels are relative to the off state of the selected ONT 101. A comparison of the idle channel power (measured at block 202) to the requested low transmission power level, and of the idle channel power level to the requested high transmission power level, is made at block 208. The compared power levels will be nearly identical to the requested power levels only for the rogue ONT, which is stuck in either the low or high power transmitting state. In other words, for all properly functioning ONTs, the power levels of the requested low and high transmissions should both be significantly higher than the idle power.

Thus, if at block 210, a determination is made that the compared power levels are nearly identical, (e.g., within a predetermined range of one another) then at block 212 an alarm is signaled from the OLT 106 in the above-described manner, to, for example, notify the network operator of the identification or serial number of the failed ONT(s), thereby simplifying the task of locating and removing it. For example, the OLT 106 knows the identification or serial number of the failed ONT, prior to signaling that information by pre-associating a stored version of that information with the ONT selected at block 206, and/or through signals received from that ONT.

If a determination is made at block 210 that the power levels are not nearly identical, then a determination is made at block 214 whether the selected ONT 101 was the last ONT 101 in the ODN to be tested. If so, then a notification is communicated to the network operator at block 218 that a rogue ONT exists, but that the particular ONT has not been identified. If a determination is made at block 214 that there are more ONTs 101 in the ODN to be tested (i.e., the last ONT has not yet been tested), then at block 216 an index is incremented to test another ONT 101, which continues the loop 205-216 until all the ONTs 101 have been tested (“Yes” at block 214).

Thus, advantageously, problem ONTs can be identified before ranging by performing an initial check on all of the ONTs 101, and if any problem ONTs exist, the network operator can be notified. Since networks are running most of the time, this allows a problem ONT to be detected and repaired before another problem in the network occurs.

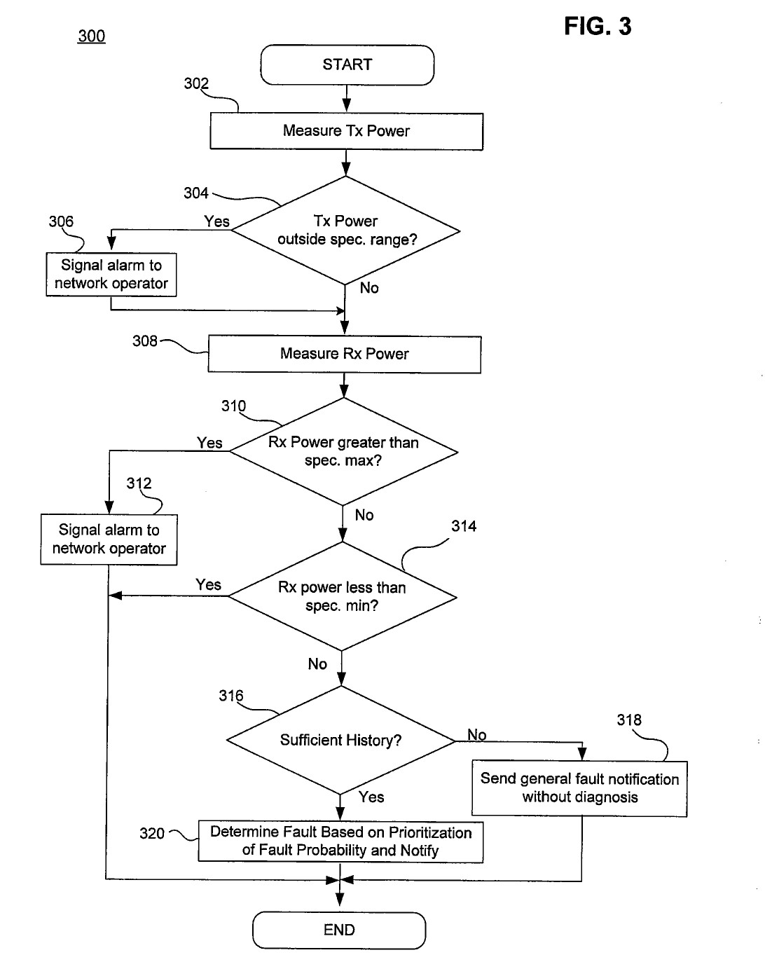

In another aspect of the present invention, downstream signal power levels (referred to as transmit (Tx) power) from an OLT 106 and upstream signal power levels (referred to as receive (Rx) power) from the ONTs 101, respectively, are monitored for signal strength to enable failures to be detected. For example, when the measured power levels are outside known or otherwise predetermined operating limits for the applicable network device, then, using a time frame for the failure and the failure level, an alarm signal categorizing the failure is effected to the system (e.g., to the network operator). By monitoring the ONTs 101, the present invention can detect whether a change has been occurring slowly (e.g., indicative of a laser problem) or whether it just occurred (indicating e.g., that a link, cable, or other component in a communication path has been damaged). The alarm can specify the likely cause of the failure, such as, for example, a dirty fiber connection, a kinked fiber, or a decaying transmitter (e.g., such as the transmitter's laser), and the like. This aspect of the present invention will now be described in more detail with reference to FIG. 3.

FIG. 3 is a flowchart illustrating a process 300 for identifying PON component problems based on signal level histories, according to the present embodiment of the invention. It should be understood that process 300 can be performed periodically or as otherwise desired, depending on applicable operating criteria. In addition, as will be discussed below in more detail, respective blocks of process 300 can be run on multiple ONTs 101 and OLTs 106. For simplicity, however, process 300 is shown and described with reference to a single ONT 101 and OLT 106.

At block 302, power meter 110 in OLT 106 measures OLT 106 transmit signal power level (Tx power). This block can be controlled by microprocessor 112 to periodically record OLT 106 Tx power and generate a history of power levels corresponding to the tested OLT 106, over a predetermined time period. If a determination is made at block 304 that the OLT 106 Tx power is outside a specified range, then at block 306 an alarm is signaled in the above manner (e.g., to the network operator) indicating that the tested OLT 106 has a fault. Such a fault typically is indicative that the OLT's 106 laser (not shown) has a problem.

In addition to testing an OLT 106, one or more ONTs 101 can be periodically tested. It should be understood that while process 300 illustrates the case for testing a single ONT 101, it is within the scope of this invention to test several ONTs 101 using the same procedure by indexing through each ONT 101 on an ODN.

At block 308, power meter 110 measures the upstream signal power (referred to as receive or Rx power) of an ONT 101 under test. In turn, a determination is made at block 310 whether the Rx power is greater than a specified maximum. If so, then an alarm is signaled in the above-described manner (e.g., to the network operator) at block 312 indicating a fault in the tested ONT 101. Typically, this type of fault is indicative of a laser failure. However, it may also be indicative that the tested ONT 101 was physically placed too close to the OLT 106 and/or too little attenuation has been inserted between OLT 106 and the tested ONT 101.

If a determination is made at block 310 that the Rx Power is not greater than a specified maximum, then at block 314 a determination is made as to whether the Rx power is less than a specified minimum. If a determination is made at block 314 that the Rx power is below a specified minimum, this means that there is no problem with the ONT 101 under test and the process ends (or, in some embodiments returns to block 308 if additional ONTs are to be tested, although for convenience this is not shown in FIG. 3). However, if a determination is made at block 314 that the Rx power is not less than a specified minimum, then at block 316 a determination is made as to whether sufficient history on the ONT 101 under test been previously recorded (e.g., by examining whether the memory 114 stores a predetermined amount of recorded data and/or a predetermined number of data recordation times). For example, as discussed above, microprocessor 112 periodically records the power levels of the ONTs 101 which have been measured by power meter 110 in memory 114. The amount of data acquired to be considered “sufficient” is a design choice which can be predetermined by, for example, the network operator, as is the periodicity of the data acquisition. For example, three days of power level measurements can be sufficient to obtain an idle channel power level, or baseline low or high power levels for each ONT 101, or the transmit power level for the OLT 106, although, of course, the invention is not so limited.

If it is determined at block 316 that no history, or insufficient history, has been recorded, as can be the case in, for example, newer system installations, then at block 318 a general alarm signal is communicated in the above manner (e.g., to the network operator) signaling a general fault notification, without diagnosis. An alarm generated at block 318 typically indicates the existence of a crimped or dirty fiber connection, or other predetermined malfunction in the communication path between the OLT 106 and ONT 101. The operator can then attend to that malfunction as deemed necessary to repair it.

If a determination is made at block 316 that sufficient history exists, then at block 320 an analysis of the tested ONT's recorded history is made, and a determination is made of the type of fault that has occurred or which will occur, based on an analysis of the recorded history, and in at least some cases, by comparing the power levels measured at block 308 to that history, depending on applicable operating criteria. For example, if the Rx power suddenly has changed, then it is likely that a sudden crimp or similar predetermined optical degradation has occurred. If the change in Rx power level over a longer period of time is greater than a predetermined threshold, then it is likely that the ONT's laser is malfunctioning. Thus, by identifying predetermined trends, sudden changes, and the like, over predetermined time periods or at one or more predetermined instances in time, the existence or likelihood of future failure conditions of a type that are known to correspond to the identified trends, changes, and the like, can be readily identified. As a result, an impeding greater loss of signal that prevents communication can be predicted and the downtime to correct the service greatly reduced. On redundant systems, failure can be avoided altogether using the redundant span.

All of the above mentioned alarm signals can include the identification of the failed ONT(s) 101 or OLT 106, simplifying the task of identifying, removing and/or repairing it.

As stated above, the detection of un-modulated and modulated signals is not required for normal OLT operation. However, the present invention can detect the power levels of both of these types of signals over a configurable time frame, typically the time frame of a message, and thus is not limited for use with any particular one of those signal types. Detection of the power level of the un-modulated or modulated signals can thus advantageously be used to improve the OLT's 106 ability to detect and categorize errors.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. As but one example, while the invention has been described in the context of employing software programs to implement the methods of this invention, in other embodiments the methods may be performed by circuitry or other hardware modules used within or in association with, for example, OLT 106 and/or ONT 101. Thus, broadly construed, the present invention should not be limited by any of the above described exemplary embodiments, but should be defined only in accordance with the following claims and their equivalents.

In addition, it should be understood that the figures, which highlight the functionality and advantages of the present invention, are presented for example purposes only. The architecture of the present invention is sufficiently flexible and configurable, such that it may be utilized in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the blocks and processes recited in the claims need not be performed in the order presented.

What is claimed is:

1. A method for identifying an error in a passive optical network, comprising:
communicating to an optical network terminal on the passive optical network a request to transmit a response signal at a predetermined power level;
receiving the response signal in response to the request;
measuring a power level of the response signal;
comparing a predetermined channel power level to the power level of the response signal; and
determining a status of the optical network terminal based on a result of the comparing.

2. The method of claim 1, further comprising:
generating a signal indicating the status of the optical network terminal.

3. The method of claim 1, wherein the predetermined power level is at least one of a low power level and a high power level, wherein the low power level and high power level are greater than an idle channel power level.

4. The method of claim 1, further comprising:
recording the power level of the response signal.

5. An apparatus for identifying an error in a passive optical network, comprising:
a transceiver operable to communicate to an optical network terminal on the passive optical network a request to transmit a response signal at a predetermined power level and to receive the response signal in response to the request;
a power meter operable to measure a power level of the response signal;
a microprocessor operable to compare a predetermined channel power level to the power level of the response signal and determine a status of the optical network terminal based on a result of the comparison.

6. The apparatus of claim 5, wherein the transceiver is further operable to transmit onto the passive optical network a signal indicating the status of the optical network terminal.

7. The apparatus of claim 5, wherein the predetermined power level is at least one of a low power level and a high power level, wherein the low power level and high power level are greater than an idle channel power level.

8. The apparatus of claim 5, wherein the apparatus is an optical line terminal

9. The apparatus of claim 5, wherein the power meter is housed within the transceiver.

10. The apparatus of claim 5, further comprising:
a memory operable to store the power level of the response signal.

11. A system for identifying an error in a passive optical network, comprising:
an optical network terminal on the passive optical network operable to transmit optical signals at a plurality of different power levels;
at least one node operable to communicate to the optical network terminal a request to transmit a response signal at a predetermined power level and to receive the response signal in response to the request, the at least one node also being operable to measure a power level of the response signal, compare a predetermined channel power level to the power level of the response signal, and determine a status of the optical network terminal based on a result of the comparison.

12. A system according to claim 11, wherein the at least one node also is operable to issue a notification signal indicating the status of the optical network terminal.

13. A computer program product comprising a computer usable medium having control logic stored therein for identifying an error in a passive optical network, the control logic comprising:
computer readable program code to communicate to an optical network terminal on the passive optical network a request to transmit a response signal at a predetermined power level;
computer readable program code to receive the response signal in response to the request;
computer readable program code to measure a power level of the response signal;
computer readable program code to compare a predetermined channel power level to the power level of the response signal; and
computer readable program code to determine a status of the optical network terminal based on a result of the comparison.

14. A method for identifying an error in a passive optical network, comprising:
measuring a power level of a signal on the passive optical network; and
comparing the measured power level to at least one predetermined power level; and
determining a fault based on the comparing.

15. The method of claim 14, further comprising:
determining if a predetermined history of power levels exists.

16. The method of claim 14, further comprising:
periodically recording the power level measured in the measuring on a memory.

17. The method of claim 14, further comprising:
generating a signal indicating the fault.

18. The method of claim 14, further comprising:
measuring a transmit power level of an optical-line terminal;
comparing the transmit power level to a predefined power level; and
determining the fault based on the comparing of the transmit power level to the predefined power level.

19. The method of claim 14, wherein the power level of the signal on the passive optical network is a receive power level from an optical network terminal.

20. An apparatus for identifying an error in a passive optical network, comprising:
a power meter operable to measure a power level of a signal on the passive optical network; and
a microprocessor operable to compare the measured power level to at least one predetermined power level and determine a fault based on the comparison.

21. The apparatus of claim 20, wherein the microprocessor is further operable to determine if a predetermined history of power exists.

22. The apparatus of claim 20, further comprising:
a memory operable to periodically record the power level measured by the power meter.

23. The apparatus of claim 20, further comprising:
a transceiver operable to transmit a signal onto the passive optical network and receive a signal from the passive optical network.

24. The apparatus of claim 20, wherein the power meter is further operable to measure a transmit power level of the apparatus, and
the microprocessor is further operable to compare the transmit power level to a predefined power level and determine the fault based on the comparison of the transmit power level to the predefined power level.

25. The apparatus of claim 20, wherein the apparatus is an optical line terminal.

26. The apparatus of claim 23, wherein the power meter is housed within the transceiver.

27. The apparatus of claim 20, wherein the power level of the signal on the passive optical network is a receive power level from an optical network terminal.

28. A system for identifying an error in a passive optical network, comprising:
an optical network terminal; and
at least one node operable to measure a receive power level of a receive signal from the optical network terminal on the passive optical network and compare the receive power level to a predetermined power level to determine a fault based the comparison.

29. The system of claim 28, wherein the node is further operable to measure a transmit power level of a transmit signal issued by the at least one node on the passive optical network and compare the measured transmit power level to at least one predetermined power level and determine a fault based on the comparison of the transmit power level and the at least one predetermined power level.

30. A system according to claim 28, wherein the at least one node also is operable to issue a notification signal indicating the fault.

31. A computer program product comprising a computer usable medium having control logic stored therein for identifying an error in a passive optical network, the control logic comprising:
computer readable program code to measure a power level of a signal on the passive optical network;
computer readable program code to compare the measured power level to at least one predetermined power level; and
computer readable program code to determine a fault based on the comparison.
